(19) United States
(12) Patent Application Publication
(10) Pub. No.: US 2011/0205432 A1
(43) Pub. Date: Aug. 25, 2011

(54) ELECTRONIC EQUIPMENT WITH DEMONSTRATION ROUTINE

(75) Inventors: Perry Gerard Mevissen, Eindhoven (NL); Willem Franciscus Johannes Hoogenstraaten, Eindhoven (NL)

(73) Assignee: KONINKLIJKE PHILIPS ELECTRONICS N.V., EINDHOVEN (NL)

(21) Appl. No.: 13/126,488

(22) PCT Filed: Oct. 29, 2009
(86) PCT No.: PCT/IB2009/054797

§ 371 Date: Apr. 28, 2011

(30) Foreign Application Priority Data
Nov. 7, 2008 (EP) 08168621.4

(51) Int. Cl. H04N 5/04

(52) U.S. Cl. 348/500; 348/E05.009

(57) ABSTRACT

The invention relates to electronic equipment (2) capable of presenting a demonstration routine. The electronic equipment comprises a processing unit for receiving and processing a synchronization signal and a memory for storing a demonstration routine. The processing unit is adapted for presentation of the demonstration routine in accordance with the synchronization signal. A synchronous presentation of the demonstration routine may thereby be achieved on an ensemble of electronic equipment. In an embodiment the electronic equipment is an ensemble of TV-sets synchronously presenting an electronic sticker (3) overlaid on the display.

### FIELD OF THE INVENTION

The invention relates to electronic equipment capable of presenting a demonstration routine, an ensemble of electronic equipment capable of presenting a demonstration routine, a method for presenting a demonstration routine with electronic equipment and a computer program product, when in use on a processing unit, to cause electronic equipment to perform a method for presenting a demonstration routine with electronic equipment.

### BACKGROUND OF THE INVENTION

In a typical shop selling electronic equipment, a number of brands from a variety of manufactures are sold. The equipment is often sorted according to type of equipment, i.e. all TV-sets are grouped together, all DVD-players are grouped together etc. Moreover, within each group of equipment of the same type, the equipment may further be sorted according to a number of different criteria. From the manufacture's point of view, it would often be preferred if all the products from the manufacture were grouped together, i.e. it would be preferred if all TV-sets from a given manufacture were grouped together. However, this is often not the case. In general, electronic equipment is sorted in accordance with a given specification. For example, it is often seen that TV-sets are grouped according to screen size. Irrespective of the sort criteria, when a large number of different products are offered for sale, specific products may disappear in the mass and a given brand does not stand out to the potential buyer. This is even more so, if equipment is sorted according to a specific specification. A general concern of manufactures is that they generally have no, or very little, control over their products, in terms of placement and other means of attracting attention to the products, once they are in the shop.

In the internationally published patent application WO 2006/077532 it is suggested to automatically ensure optimal operation mode of an electronic product when it is detected that the product is in a shop environment, and thereby ensuring that once the potential buyer has been attracted to the given product, that the electronic product is in the full performance operation mode to give the potential buyer the best possible impression of the product. The disclosure is however silent about how to ensure that the potential buyer is attracted to the product in the first place.

The inventors of the present invention have appreciated that improved means of ensuring the attention of a potential buyer to a given brand would be of benefit, and have in consequence devised the present invention.

### SUMMARY OF THE INVENTION

The present invention seeks to provide improved technical means for ensuring attention of a potential buyer to a specific product in a situation where there is a high risk that the specific product disappears in the mass, such as in a typical shop environment. The invention is defined by the independent claims. The dependent claims define advantageous embodiments. Preferably, the invention alleviates, mitigates or eliminates one or more disadvantages of the prior art, singly or in any combination.

It may be seen as an object of the present invention to provide electronic equipment which is capable of attracting attention to a person. More specifically, it may be seen as an object of an embodiment of the invention to ensure means of attracting attention in shop environment where a large number of electronic equipment devices are present. Even more specifically, it may be seen as an object of an embodiment of the invention to provide such means in a cost efficient way, so that electronic equipment with the functionality of the present invention has no, or only little, added cost.

To this end, in a first aspect, the invention relates to electronic equipment comprising:

a processing unit for receiving and processing a synchronization signal; and

a memory for storing a demonstration routine;

wherein the processing unit is adapted for presenting the demonstration routine in accordance with the synchronization signal.

The inventors have had the insight that a synchronous change or appearance of a visual or audio feature, or any humanly perceptible effect, attracts attention to a person exposed to such features. It is the synchronized effect that ensures that the potential buyer is attracted to the product in the first place. Since most electronic equipment is provided with processing and storage capabilities, the extra cost of pre-programming the equipment with a demonstration mode in accordance with an embodiment of the present invention is minimal, since extra hardware may not be needed, and all models of a specific electronic equipment may be provided with the same functionality, that is, the same software element.

Embodiments of the invention may be implemented into a large number of electronic equipment, such as, but not limited to, electronic equipment selected from the group consisting of: a TV-set, a monitor, a video recorder, a DVD player, a Blu Ray player, a projector, a hard disk recorder, a media centre, an audio player, a CD player, a radio, a computer device, a computer game device, a mobile phone, a set top box and a hi-fi system. Most electronic equipment is provided with a processing unit, for example in the form of a field-programmable gate array (FPGA) on which a software-capable microprocessor is implemented. Moreover, most equipment is also provided with a memory unit. A large number of standard memory units exist, such as volatile, non-volatile, ROM, RAM, Flash, optical, magnetic memory or hard disk, etc.

The synchronization signal may in different embodiments be generated by the electronic equipment, i.e. typically by means of the processing unit, or be received from an external source. The synchronization signal may be in any form suitable for triggering the presentation of the demonstration routine.

The demonstration routine may be selected in accordance with the type of the electronic equipment. For example, for a TV-set or other visually based equipment, the demonstration routine may be video message, such as an electronic sticker, visually overlaid on the display, an overlaying animation, etc. Whereas for audio based equipment, the demonstration routine may be a sound change, a sound modulation, an audio message, a tone sequence etc.

While the invention may improve any type of electronic equipment, the invention is specifically advantageous in electronic equipment which is not intended for, or at some point in time is not capable of, advanced communicative connection to other electronic equipment, for example a TV-set. A TV-set is intended for being connected to a signal provider, in order to be able to present audiovisual content to the viewer. Most TV-sets are not provided with computing facilities which enable advanced communicative connection to other electronic equipment. Even in the case where the electronic equipment, such as a TV-set, does have an advanced communication channel this is not always available or enabled, for example in a Shop environment. However, most TVs are provided with processing facilities, e.g. in order to improve image quality displayed on the screen, and with a memory unit, e.g. in order to store menu contents, user settings, firmware etc.

In an advantageous embodiment, the electronic equipment further comprises a receiver unit for receiving a signal to be presented by the electronic equipment, and wherein the processing unit is further adapted for performing an analysis of the signal that is received and extracting the synchronization signal from the signal that is received. The inventors of the present invention have realized that in most shops, most, if not all, electronic equipment receives a common signal, i.e. the same signal, to be presented by the equipment. By extracting the synchronization signal from the signal that is received, apparently non-connected independent electronic equipment may nevertheless be synchronized based on this distributed common signal. The receiver unit may be any component capable of receiving a signal to be presented by the electronic equipment.

In an advantageous embodiment, the analysis of the signal that is received is based on extracting a signal feature from the signal that is received. This signal feature may, in an embodiment, be an image property of an image or a sequence of images of a video signal. However, other types of signal features may also be extracted. Many types of electronic equipment analyze the signal that is received, for example a TV-set analyzes the signal that is received with respect to interlacing and other image improving aspects. Thus, many devices already support appropriate routines that may be used or modified in order to implement the functionality into the device. The image property may be a rarely occurring property to ensure a certain offset time between presentations of the demonstration routine.

In embodiments, conditions for extracting the signal feature may be defined in terms of setting specific criteria, for example in terms of setting one or more thresholds to be reached for a specific signal property. It may be advantageous to adaptively update preset criteria. By use of criteria that may be adaptively updated, more general routines for extracting features from a synchronization signal may be used, since only the general criteria needs to be predefined, whereas specific values may be set in accordance with the specific synchronization signal.

In an embodiment, the electronic equipment may further comprise a communication module, wherein synchronization signal is received via the communication module. Devices which are not connected, as described above, may need some time before they are synchronized, since the signal analysis may introduce time off-sets. By use of a communication module, the devices may communicate the synchronization signal to each other in a direct or indirect manner. By using a communication module it may be ensured that the demonstration routine is synchronized immediately. The communication module may be a wireless module such as a WiFi-module or a wired module, such as an Ethernet module.

In an advantageous embodiment, the electronic equipment is a node in a distribution network, where the ensemble of distribution nodes receives a common signal, i.e. the same signal, to be presented by each unit of electronic equipment in the ensemble of nodes. In a shop environment the distribution network may be the network of equipment receiving the same signal. In the network two types of nodes may be present. In one type, the electronic equipment may implement the functionality of embodiments of the present invention. In another type, the electronic equipment does not need to implement the functionality of embodiments of the present invention. Equipment implementing the functionality of embodiments of the present invention will be provided with an advantage over equipment that does not, since such equipment will standout to the potential buyer by synchronously presenting the demonstration routine.

In a second aspect, the invention relates to a method for presenting a demonstration routine with electronic equipment, the method comprising:

receiving and processing a synchronization signal; and

retrieving a stored demonstration routine;

wherein the demonstration routine is presented by the electronic equipment in accordance with the synchronization signal.

In a third aspect, the invention relates to a computer program product, when in use on a processing unit, to cause electronic equipment to perform method of the second aspect.

The computer program product of the third aspect may implement the method of the second aspect as a computer algorithm to provide the functionality of embodiments of the first aspect to general electronic equipment.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 schematically illustrates the TV section of a shop selling electronic equipment;

FIG. 2 schematically illustrates a TV-set comprising various modules or units in accordance with embodiments of the present invention; and

FIG. 3 schematically illustrates the functionality of a TV-set in accordance with embodiments of the present invention.

### DESCRIPTION OF EMBODIMENTS

The following description focuses on embodiments of the present invention applicable to TV-sets in a shop environment. It is to be understood that the invention is not limited to this type of electronic equipment. Embodiments relating to other types of electronic equipment are also described.

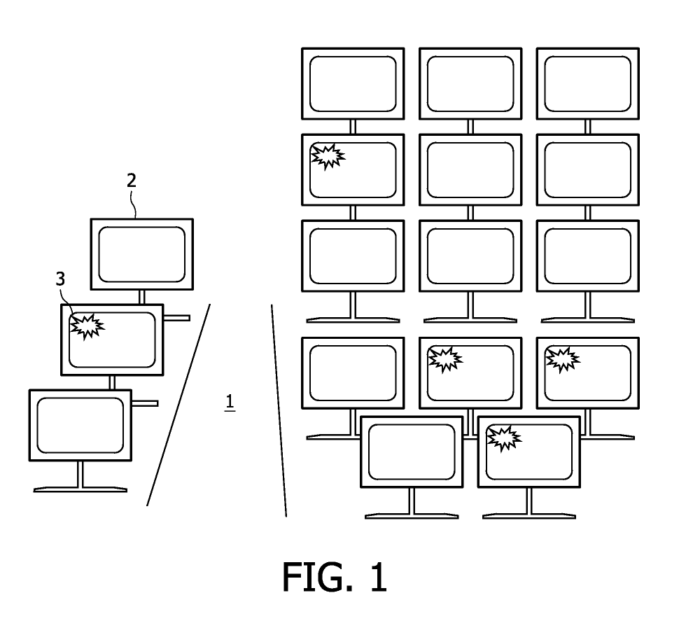

FIG. 1 schematically illustrates the TV section of a shop selling electronic equipment. In many shops TV-sets are sorted according to a non-brand related placement criterion. A potential buyer pacing along the aisle 1 is confronted with a large number of TV-sets 2. Here 17 TV-sets are shown, however many more may be present and distributed over a large area.

In a typical setup, all TV-sets receive the same video signal. This may be a broadcast signal, such as a news program, or a recorded signal, such as a commercial or a film. For a shop administrator this is a very convenient way of operating the TV-sets. However, for a manufacture this is not an optimal situation, since there is a high risk that their brand disappears in the mass. Moreover, often the video signal is a looped signal, since again this in convenient for the shop administrator. For example, the video signal may periodically repeat in a looped manner.

A synchronous change or appearance of a visual or audio feature will attract the attention of the potential buyer to those TV-sets exhibiting the synchronized feature. The synchronized effect may, in fact, be any effect perceptible to a human and does not only need to be audible or visible. As a specific example, all TV-sets show a video clip, and at a certain instance in time, each TV-set of a given manufacture, say for example Philips, may synchronously overlay an electronic sticker 3, for example the Philips logo. In FIG. 1 the reference numeral 3 is only shown on one TV-set, but of course the electronic sticker 3 or a similar or comparable electronic sticker may appear on all synchronized TV-sets, as shown on a selection of other TV-sets in FIG. 1. The attention of the potential buyer will immediately be drawn to TV-sets having a synchronized effect. As another example, each TV-set may synchronously flash an ambient light feature, such as an Ambilight backlight in Philips TV-sets, if such a feature is implemented in the TV-sets.

In the following there is disclosed an embodiment of how to implement the above-described functionality for independent TV-sets which are not connected in a communication network. The implementation assumes that all TV-sets receive the same video signal. The video signal may be an arbitrary video signal.

Each TV-set comprises a processing unit which is pre-programmed with the same demonstration software. Each demonstration software routine implements the same signal analysis algorithm. It may be advantageous to base the signal analysis algorithm on pre-existing image analysis algorithms. For example, many TV-sets extract a number of signal properties of an image or sequence of images. If this is not the case, a routine which extracts a given signal property may be implemented in the TV-set's processing unit. Such implementation is typically done by means of a software routine, but may also be provided by a hardware unit or a combination of software and hardware. Various video signal properties may be used, such as constant durations of a signal property, scene changes, contrast levels, etc.

Concurrently with presenting the video signal on the TV display, the video signal is analyzed. In an embodiment, the analysis phase may search for periods with a constant signal property, such as periods of constant sharpness. Generally long periods with a constant signal property are not found in an arbitrary video signal, however if a threshold in time of the period of a constant signal property is set to be too low, such periods may be found quite often. An adaptive method may be used in order to ensure an appropriate interval to repeat the synchronization and, consequently, to attract the consumer. As an example it may be desired to synchronously show the electronic sticker 3 one time with at least 5 minutes in between. Since the video signal is arbitrary, a repeating time with constant period may not be possible, rather a seeded semi-random pattern is obtained. Advantageously, since the video sequence may be the same for all TV-sets and since the analysis routine may be the same for all TV-sets, the deduced sequence will be the same for all TV-sets, even though the deduced sequence may not be periodic with a constant period.

The TV-sets implementing the functionality of embodiments of the present invention may constitute an ensemble of electronic equipment wherein each TV-set is a node in a distribution network.

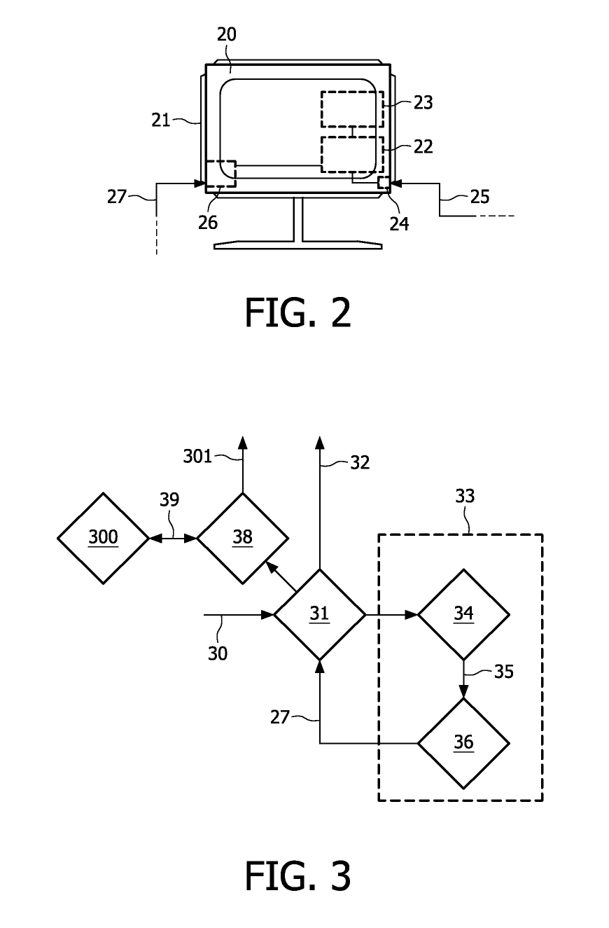

FIG. 2 schematically illustrates a TV-set comprising various modules or units in accordance with embodiments of the present invention.

Electronic equipment in the form of a TV-set 20, e.g. equipment offering an ambient light feature, such as an Ambilight backlight 21 as present in many Philips TVs, is provided with a processing unit 22 and a memory 23 for storing one or more demonstration routines. The TV-set 20 may also be provided with a receiver unit 24 for receiving a signal 25. In an embodiment, the TV-set 20 may also be provided with a communication module 26. A synchronization signal 27 may in an embodiment be extracted or derived from the signal and/or may be received directly as synchronization signal 27 via the communication module 26. The synchronization signal 27 may therefore be received separately and distinct from the signal 25.

FIG. 3 schematically illustrates the functionality of a TV-set in accordance with embodiments of the present invention. In this embodiment the signal 25 is a video signal that is received by the processing unit 31. The processing unit on one hand performs the normal processing of the video signal 30 in order for it to be shown on a display, the signal to be displayed 32 is output to the appropriate components of the TV-set 20. Although not shown in FIG. 3, in an embodiment, the video signal 30 may be analyzed by the processing unit 31 in order to extract the synchronization signal 27 from the video signal 30.

In a phenomenological description, the video signal 30 may also be input into an analysis unit 33 in order to extract the synchronization signal 27. In an embodiment a signal feature is extracted in a signal feature unit 34, typically in the form of an image property 35 of an image or sequence of images of the video signal 30. The synchronization signal 27 may be based on the image properties and constructed in a number of ways. In one embodiment the following general routine is used.

The signal feature unit 34 analyzes the video signal 30 in segments of, say 5 minutes. Within each 5 minute segment, the signal feature unit 34 extracts durations of constant signal property, e.g. durations of constant sharpness, color, black level or other signal property. For each segment the time at which the longest duration of constant signal property occurred is detected. This may be obtained by storing the time-instant it occurred if the duration was longer than the one that is already stored each time a duration of constant signal property is detected. That is, a threshold is adaptively set to the duration of the stored duration. Subsequently, the synchronization signal 27 may be generated in a synchronization signal unit 36, for example by outputting a command. The command may be a command to present a demonstration routine 39 six minutes after each time-instant at which the longest detected constant duration of the analyzed signal property occurred.

The processing unit 31 ensures that the demonstration routine 39 is presented in accordance with the synchronization signal 27. This may be obtained by calling a presentation unit 38, which accesses and fetches the demonstration routine 39 from the storage 300 and forwards 301 the demonstration routine 39 to the appropriate components of the TV-set 20.

An advantage of the above-mentioned embodiment is that it works with an arbitrary signal. In another embodiment, the processing unit 31, or the analysis unit 33, may be further adapted for detecting an anomaly event in the received signal. Such an anomaly may be a glitch or a signal format change, such as a channel change, etc. Upon detection of the anomaly event, the synchronization signal 27 may be set as a periodic signal triggered by the anomaly event. The advantage is that instead of a semi-random synchronization pattern, a periodic synchronization pattern can be generated. However, in order to ensure that all TV-sets are synchronized it is advantageous to use only anomalies which are common to all TV-sets. Since it cannot be ensured that a unique anomaly signal is detected electronic equipment may start out with a general routine as disclosed above, and then if an anomaly signal is detected; overrule this general routine and replace the extracted semi-random presentation sequence with the periodic presentation sequence triggered by the occurrence of the anomaly.

In the event that the shop agrees to use a video signal that comprises preformatted synchronization information, the processing unit 31, or the analysis unit 33, may extract such synchronization information and base the synchronization signal 27 on this.

In the event the video signal 30 comprises an imposed text signal, such as a Teletext signal as is typically imposed in the blanking interval of a broadcast signal, the synchronization signal 27 may be extracted from the imposed text signal. This may, for example, be done by basing the synchronization signal 27 on the clock of the Teletext signal. Such that a demonstration routine 39 is presented every minute, every second minute, etc.

It is foreseen that TV-sets in the near future will include communication module 26, either a wireless module or wired for cable based module. In such a situation, the synchronization signal 27 may be received via the communication module 26, for example wirelessly. Current network protocols such as the UPnP/DLNA protocol facilitate the functionality that the TV-sets search and find each other and communicate explicitly the synchronization signal 27 or any parameters to be used in order to build or detect the synchronization signal 27. When the TV-sets are aware of each other, the demonstration routine 39 may be tailored to the specific models in the shop. For example, the electronic sticker 3 may mention the newest model in the shop, the one with the largest screen, etc.

Embodiments of the invention have been disclosed with respect to electronic equipment of the type TV-set. Nevertheless, aspects of the invention may be implemented in a large number of different electronic equipment.

In an embodiment, the above-described routines may be implemented into other types of equipment for presenting video content, such as DVD-players, Blu Ray players, Hard disk recorders, etc.

In an embodiment, the electronic equipment may be an audio device, such as a radio. For a radio the radio signal may be analyzed instead of the video signal, or the Radio Data System (RDS) signal may be analyzed if available. Radio Data System, or RDS, is a communications protocol standard from the European Broadcasting Union for sending small amounts of digital information using conventional FM radio broadcasts. Furthermore, the synchronization signal 27 may also be received directly. As an example of the demonstration routine 39 used to attract the attention of a consumer in an audio based device, the sound may be raised, or a tone or tone sequence may be played, for a number of seconds for the models implemented with an embodiment of the present invention.

An embodiment of the invention may also be implemented in a computer, such as a laptop computer. Laptop computers typically do not receive a distributed signal. However they may be connected with a cable connection or via a wireless network. Synchronization signals may be communicated via the cable or wireless connection. In such a situation each laptop computer can also be arranged to provide a synchronized demonstration routine upon reception or detection of the synchronization signal 27.

The invention can be implemented in any suitable form including hardware, software, firmware or any combination of these. The invention or some features of the invention can be implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. Electronic equipment comprising:
a processing unit (22) for receiving and processing a synchronization signal (27); and
a memory (23) for storing a demonstration routine (39);
wherein the processing unit is adapted for presenting the demonstration routine in accordance with the synchronization signal.

2. The electronic equipment according to claim 1, wherein the electronic equipment further comprises a receiver unit (24) for receiving a signal (25) to be presented by the electronic equipment, and wherein the processing unit is further adapted for performing an analysis of the signal (25) and extracting the synchronization signal (27) from the signal (25).

3. The electronic equipment according to claim 2, wherein the analysis (33) of the signal (25) is based on extracting a signal feature (35) from the signal (25).

4. The electronic equipment according to claim 3, wherein the signal (25) is a video signal (30), and wherein the signal feature is an image property of an image or a sequence of images of the video signal (30).

5. The electronic equipment according to claim 3, wherein a criterion for extracting the signal feature is adaptively updated.

6. The electronic equipment according to claim 2, wherein the processing unit is further adapted for detecting an anomaly event in the signal (25) and upon detection of the anomaly event setting the synchronization signal (27) as a periodic signal triggered by the anomaly event.

7. The electronic equipment according to claim 2, wherein the signal comprises preformatted synchronization information; and wherein the synchronization signal (27) is based on the preformatted synchronization information.

8. The electronic equipment according to claim 2, wherein the signal (25) comprises an imposed text signal; and wherein the synchronization signal (27) is extracted from the imposed text signal.

9. The electronic equipment according to claim 1, wherein the electronic equipment further comprises a communication module (26) and wherein synchronization signal (27) is received via the communication module.

10. The electronic equipment according to claim 2, wherein the electronic equipment is a node in a distribution network, and wherein an ensemble of distribution nodes in the distribution network receives a common signal to be presented by each electronic equipment in the ensemble of nodes.

11. The electronic equipment according to claim 1 selected from the group consisting of: a TV-set, a monitor, a video recorder, a DVD player, a Blu Ray player, a projector, a hard disk recorder, a media centre, an audio player, a CD player, a radio, a computer device, a computer game device, a mobile phone, a set top box and a hi-fi system.

12. An ensemble of electronic equipment in accordance with claim 1, wherein each entity (20) in the ensemble of electronic equipment comprising:
a processing unit (22) for receiving a synchronization signal (27); and
a memory (23) for storing a demonstration routine (39);
so that each entity in the ensemble of electronic equipment present the demonstration routine in accordance with the synchronization signal (27).

13. A method for presenting a demonstration routine (39) with electronic equipment, the method comprising:
receiving and processing a synchronization signal (27); and
retrieving a stored demonstration routine;
wherein the demonstration routine is presented by the electronic equipment in accordance with the synchronization signal (27).

14. A computer program product, when in use on a processing unit, to cause electronic equipment to perform method of claim 13.
